(19) United States
(12) Patent Application Publication
(10) Pub. No.: US 2015/0196922 A1
(43) Pub. Date: Jul. 16, 2015

(54) CRUSHER FEED HOPPER HATCH

(71) Applicant: SANDVIK INTELLECTUAL PROPERTY AB, Sandviken (SE)

(72) Inventors: Axel Bergman, Malmo (SE); Bengt-Arne Eriksson, Svedala (SE); Fredrik Eriksson, Malmo (SE); Mikael M. Larsson, Eslov (SE); Patric Malmqvist, Svedala (SE)

(73) Assignee: SANDVIK INTELLECTUAL PROPERTY AB, Sandviken (SE)

(21) Appl. No.: 14/418,558

(22) PCT Filed: Jun. 20, 2013
(86) PCT No.: PCT/EP2013/062864

§ 371 Date: Jan. 30, 2015

(30) Foreign Application Priority Data
Aug. 2, 2012 (EP) 12179087.7

(51) Int. Cl. B02C 23/02; B02C 2/00

(52) U.S. Cl. CPC B02C 23/02; B02C 2/007

(57) ABSTRACT

A crusher feed hopper hatch includes a door and a frame. The frame has a suitable hinge and lock mounts into which pivoting bodies are mounted and capable of functioning as either hinge or lock bodies. The door is configurable for alternate attachment to either side of the frame to be either right or left-hand opening.

### FIELD OF INVENTION

The present invention relates to a crusher feed hopper hatch and in particular, although not exclusively, to a hatch having a frame and a door in which the door may be secured to either side of the frame so as to be right or left-hand opening.

### BACKGROUND ART

Gyratory crushers are used for crushing ore, mineral and rock material to smaller sizes. Typically, the crusher comprises a crushing head mounted upon an elongate main shaft. A first crushing shell is mounted on the crushing head and a second crushing shell is mounted on a frame such that the first and second crushing shells define together a crushing gap through which the material to be crushed is passed. A driving device is arranged to rotate an eccentric assembly arranged about the lower portion of the shaft so as to cause the crushing head to perform a gyratory pendulum movement and crush the material introduced in the crushing gap. Example gyratory crushers are described in WO 2004/110626; WO 2010/123431and WO 2012/005651.

Similarly, vertical shaft impact crushers (VSI-crushers) are used in many applications for crushing hard material like rocks, ore etc., with examples described in WO 2004/020103 and WO 2010/042025.

Common to the various types of crushers is the need for the controlled feeding of material into the crusher in order to optimise the crushing action and crusher efficiency. Typically, a feed hopper is mounted at the crusher inlet and acts to guide the material into the crushing zone. In some situations the operation of the crusher may be disturbed by problems in the feeding flow of material. Such problems reduce crushing efficiency and increase the need for maintenance work. In particular, hoppers typically comprise a side access hatch to allow personnel to carry out the required maintenance work. However, conventional hatches, due to their design, impose limitations on the hopper design and installation planning. Accordingly, what is required is a hatch for a hopper that addresses these problems.

### SUMMARY OF THE INVENTION

It is an object of the present invention to provide a hatch for a crusher feed hopper having a door with a hinge mechanism that is conveniently adjustable such that the door hinge may be interchanged at various regions of the hatch frame. For example, according to the present invention, the door may be hinged at the right or left-hand side of the frame so as to be right or left-hand opening. This introduces design flexibility to the hopper and crusher construction and installation.

It is also an object of the present invention to provide a hatch for a hopper in which the door is securely lockable at the hatch frame and is prevented from unwanted opening. It is not uncommon for conventional hatches to open during crushing operations due to vibrations transmitted to the hopper by the crushing action. Accordingly, the present invention comprises a reliable lock mechanism. Furthermore, components of the lock mechanism of the subject invention are identical to those of the hinge mechanism and in particular use the same mountings at the hatch frame that mount the door in either its right or left handed hinge position. Accordingly, the function of the hinge mechanism and the lock mechanism may be interchanged with one another (without removing either components from the respective mountings) by simply removing and reattaching the door via its hinge edge.

According to a first aspect of the present invention there is provided a crusher feed hopper hatch comprising: a frame for attachment to a hopper, the frame having walls that define an opening; at least one first hinge mount positioned at a first wall of the frame; a door configured for positioning against the walls; characterised by: at least one second hinge mount positioned at a second wall of the frame; and at least one body provided at the door, the body configured to mate with either the first and the second hinge mount to pivotally mount the door at either the first or the second wall.

Preferably, the first wall and the second wall are positioned on opposite sides of the frame.

Preferably, the hatch further comprises a lock body mountable at either the first and second hinge mounts that engage with a region of the door and locks the door in position at the frame in the hatch closed position. Reference within the specification to a ‘lock body’ include the same fundamental ‘body’ component that is used to hingeably mount the door at the frame (with or without minor variation of the component parts of each respective body, including in particular, component dimensions, such as length). Preferably, when functioning as a hinge, the body is positioned towards a hinge edge of the door. The door comprises an opposed opposite lock edge that is engageable by a corresponding body positioned at the opposite side of the frame. Preferably, when functioning as a part of the lock mechanism, the body, being a lock body is pivotally mounted at either the first and the second hinge mount and comprises an engaging end to engage a region of the door.

Preferably, the lock edge of the door comprises at least one slot engageable by the engaging end of the lock body by pivoting the lock body at either the first and second hinge mount.

Optionally, the first and second hinge mount each comprise a pair of shoulders spaced apart at the wall, each shoulder having an aperture. Optionally, the body comprises a barrel having a longitudinal axis and is mountable between the pair of shoulders within each aperture so as to be rotatable within each aperture and allow the door to pivot between a hatch open and a hatch closed position. Preferably, the barrel is mounted upon an axle extending from the door, the axle having a longitudinal axis extending substantially perpendicular to the longitudinal axis of the barrel.

When functioning as a part of the lock mechanism, the lock body comprises a barrel having a longitudinal axis and is mountable between the pair of shoulders within each aperture so as to be rotatable within each aperture. Additionally, the lock body may further comprise an axle having a longitudinal axis aligned substantially perpendicular to the longitudinal axis of the barrel, the axle being adjustably mounted relative to the barrel so as to extend and retract radially relative to the longitudinal axis of the barrel.

Preferably, the hatch comprises two hinge mounts provided at each of the first and second walls; and the door comprising two bodies engageable with the two respective hinge mounts on either the first or second walls.

According to a specific implementation, component parts of the lock body may differ from component parts of the hinge body. In particular, the axle of the hinge body is shorter than the corresponding axle of the lock body. Additionally, the hinge body does not necessarily comprise a securing pin, extending through a part of the axel of the lock body so as to prevent the axel being withdrawn completely from the barrel of the lock body.

Accordingly, when switching the door between right and left hand opening, the axels of the two respective types of bodies (hinge and lock) would also be switched, due to their respective different lengths. As such, the hinge axle(s) would always be situated at the hinge side and the lock axel(s) at the lock side of the door.

Preferably, the hatch further comprises a sealing gasket extending between the door and the frame to provide a seal when the door is in a hatch closed position at the frame.

According to a second aspect of the present invention there is provided a crusher hopper comprising a hatch as described herein.

According to a third aspect of the present invention there is provided a crusher comprising a hopper as described herein.

### BRIEF DESCRIPTION OF DRAWINGS

A specific implementation of the present invention will now be described, by way of example only, and with reference to the accompanying drawings in which:

FIG. 1 is a perspective view of a crusher hopper comprising a hatch according to a specific implementation of the present invention;

FIG. 2 is a perspective view of the hatch of FIG. 1;

FIG. 3 is a perspective view of a frame part of the hatch of FIG. 2;

FIG. 4 is a front view of the frame of FIG. 3;

FIG. 5 is a rear perspective view of the door part of the hatch of FIG. 2;

FIG. 6 is a perspective view of a front side of the door part of the hatch of FIG. 2;

FIG. 7 is a hinge side view of the door of FIG. 6;

FIG. 8 is a perspective view of a hinge and/or lock part of the hatch of FIG. 2;

FIG. 9 is a side view of the hinge and/or lock of FIG. 8 mounted at the frame of the hatch of FIG. 1.

### DETAILED DESCRIPTION OF PREFERRED EMBODIMENT OF THE INVENTION

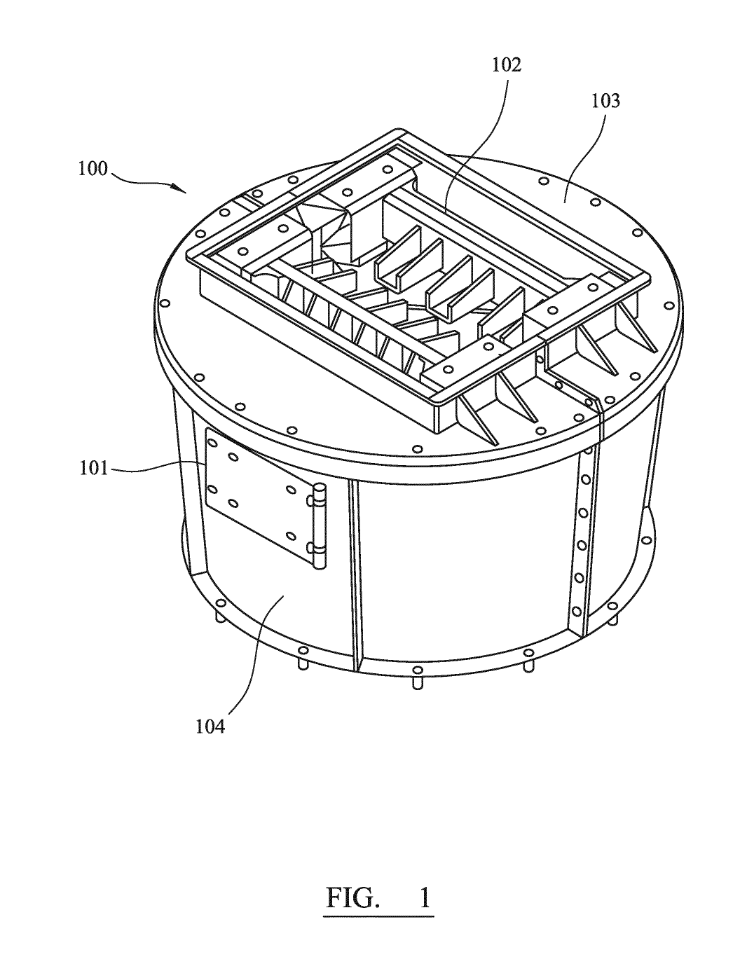

Referring to FIG. 1, a hopper 100 comprises a cylindrical side wall 104 closed at its upper end by a lid 103. A main inlet port 102 is provided at lid 103 through which material to be crushed is fed.

Side wall 104 comprises a maintenance access hatch 101 that includes a door hingeably mounted at one side and attached to a part of wall 104.

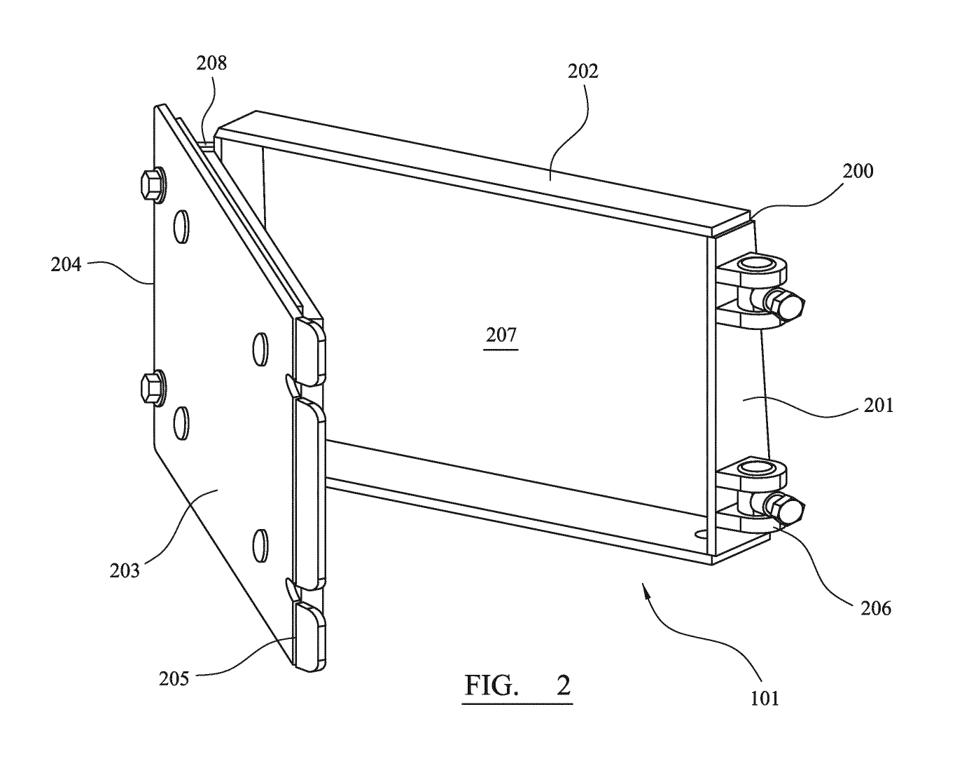

Referring to FIG. 2, hatch 101 comprises a frame 200 that is secured to hopper wall 104 typically via welding. Frame 200 comprises a first pair of opposed side walls 201 that extend substantially in a vertical direction and a second pair of opposed walls 202 that are aligned perpendicular to walls 201 and extend substantially in a horizontal direction when hopper 100 is orientated in normal use. Horizontal walls 202 comprise a length greater than vertical walls 201. A door 203 is hingeably mounted at one of vertical walls 201 via a hinge mechanism 208. Hinge mechanism 208 attaches to door 203 at or towards a hinge edge 204. An opposed lock edge 205 is configured for engagement with a lock body 206 attached to the opposite vertical wall 201 relative to hinge mechanism 208. Accordingly, door 203 is capable of pivoting/hinging about hinge mechanism 208 between an open and closed position, with FIG. 2 illustrating the open position to allow maintenance access through opening 207 defined by hatch walls 201, 202.

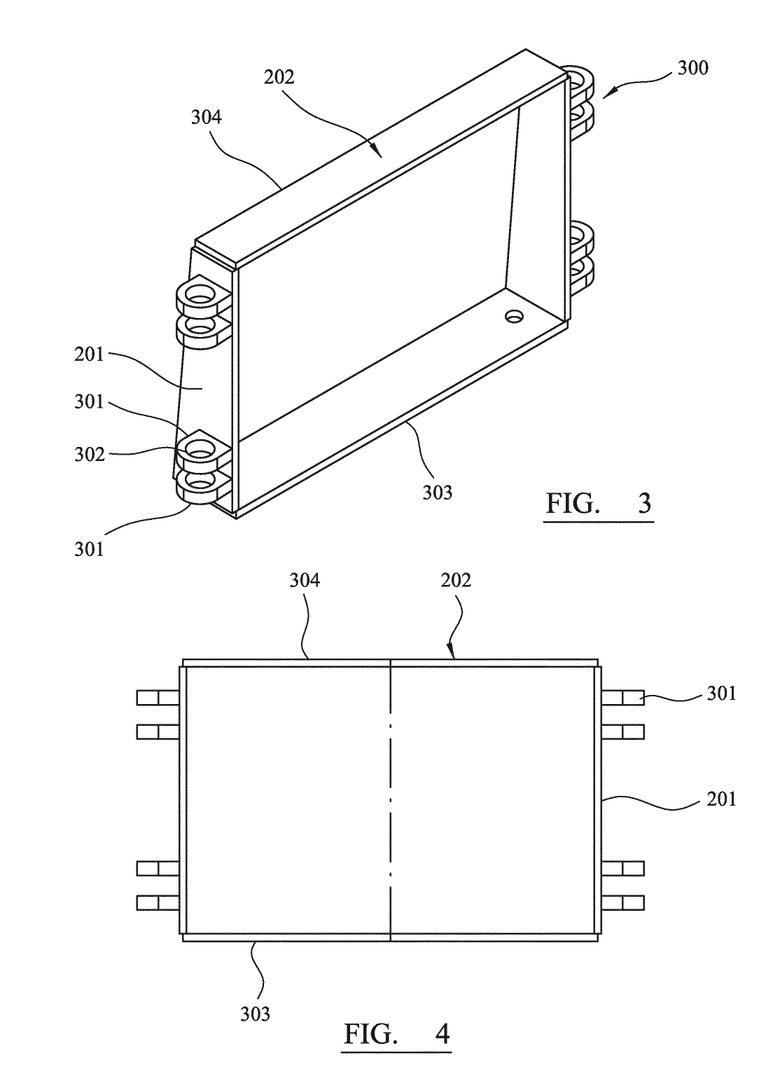

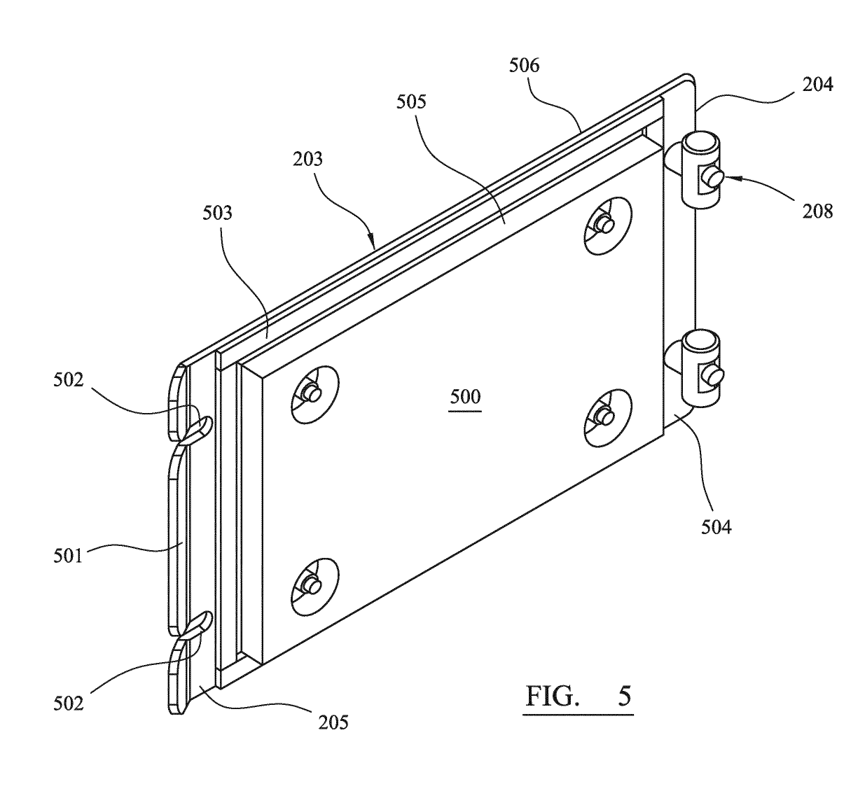

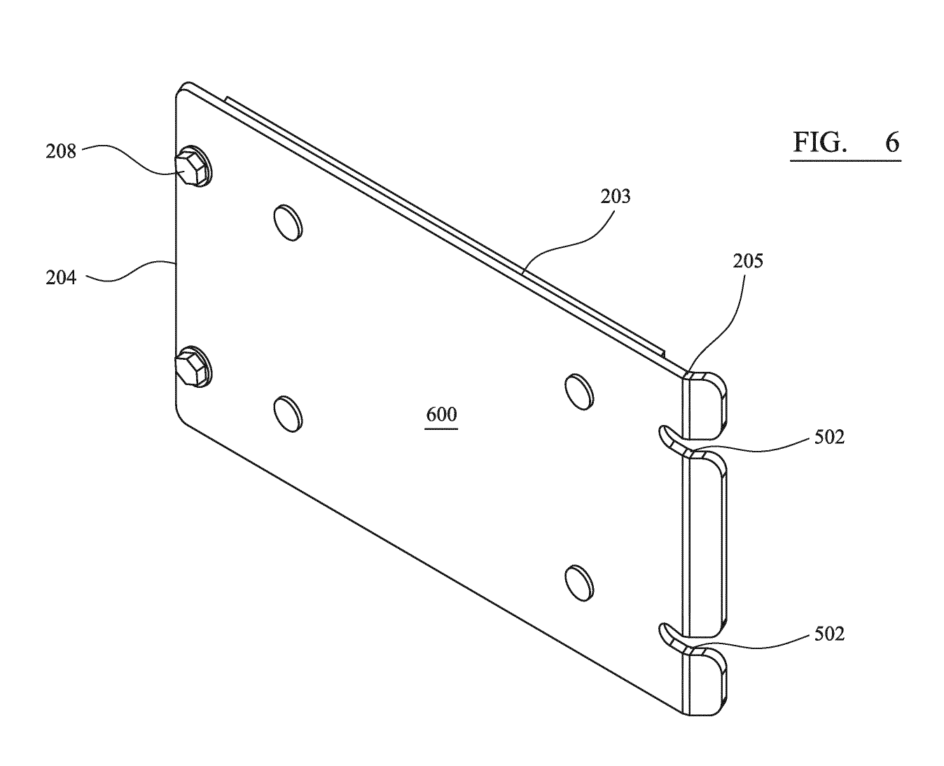

Referring to FIGS. 3 and 4, each of four hinge mounts 300, at hatch frame 200, comprise a pairs of arms 301 projecting perpendicular from vertical walls 201 in the outward direction away from opening 207. Each wall 201 comprises an upper pair of arms 301 positioned towards the top horizontal frame wall 304 and a lower pair of arms 301 positioned towards lower horizontal frame wall 303. Each arm 301 comprises an aperture 302, with the apertures 302 of each pair of arms 301 aligned concentrically. Accordingly, each pair of arms 301 forms hinge mount 300 to receive a second half of the hinge mechanism 204 in the form of a hinge body having a barrel as detailed below. Referring to FIGS. 5 to 6, door 203 comprises an inward facing surface 504 to be orientated towards opening 207 and an external facing surface 600 orientated away from opening 207. Door 203 comprises a substantially planar rectangular geometry in which hinge and lock edges 204, 205 are shorter in length than length edges 506. The dimensions of door 203 correspond approximately to the dimensions of frame 200 that defines the rectangular opening 207.

A sealing gasket 503 extends around a perimeter region of surface 504 to provide a seal as door 203 is closed against frame 200. Additionally, a mounting plate 505 is secured to door surface 504 and is dimensioned so as to fit within frame walls 201, 202 when door 203 is in the closed hatch position. Plate 505 and sealing gasket 503 may comprise a resiliently deformable material so as to provide a sealing contact against frame 200. The second half of horizontal mechanism 208 extends from door face 504 towards hinge edge 204.

The substantially planar door 203 is curved towards lock edge 205 along the edge length. A pair of slots 502 extends inwardly from the lock edge of door 203 a short distance in the direction of length edge 506. This curved region 501 defines a handle part of door 203. When in the hatch closed position, the exposed substantially planar face 500 of plate 505 occupies opening 207 such that hatch 100 is closed. The door 203 is maintained in the hatch closed position by lock bodies 206 engaging with slots 502 to prevent door 203 pivoting via hinge mechanism 208 to the door open position.

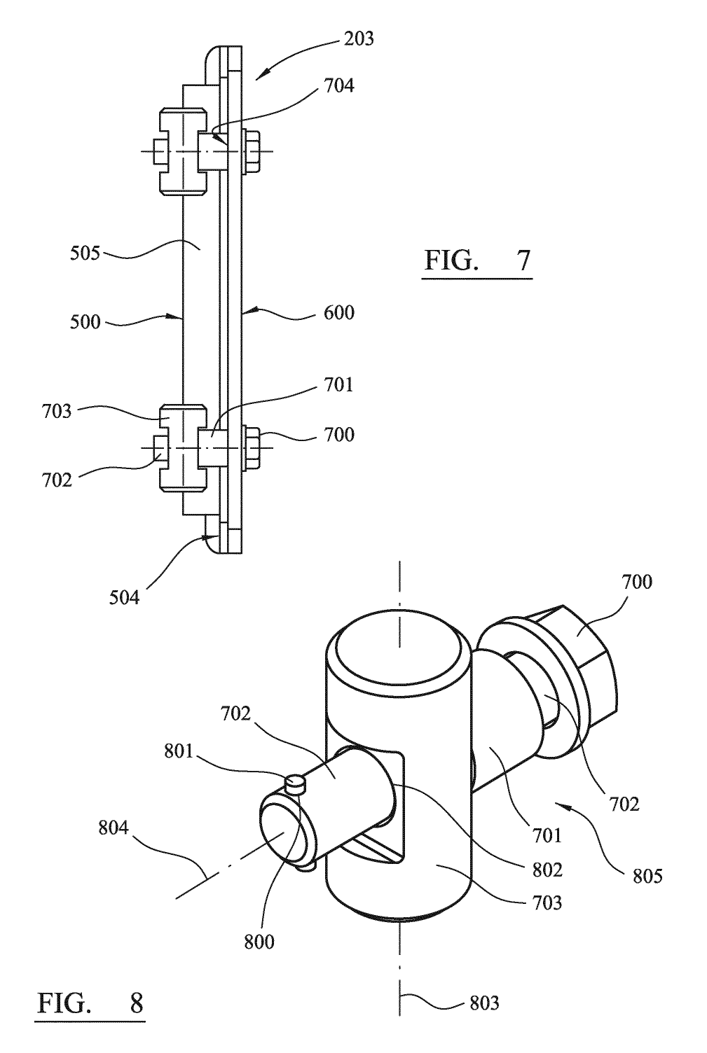

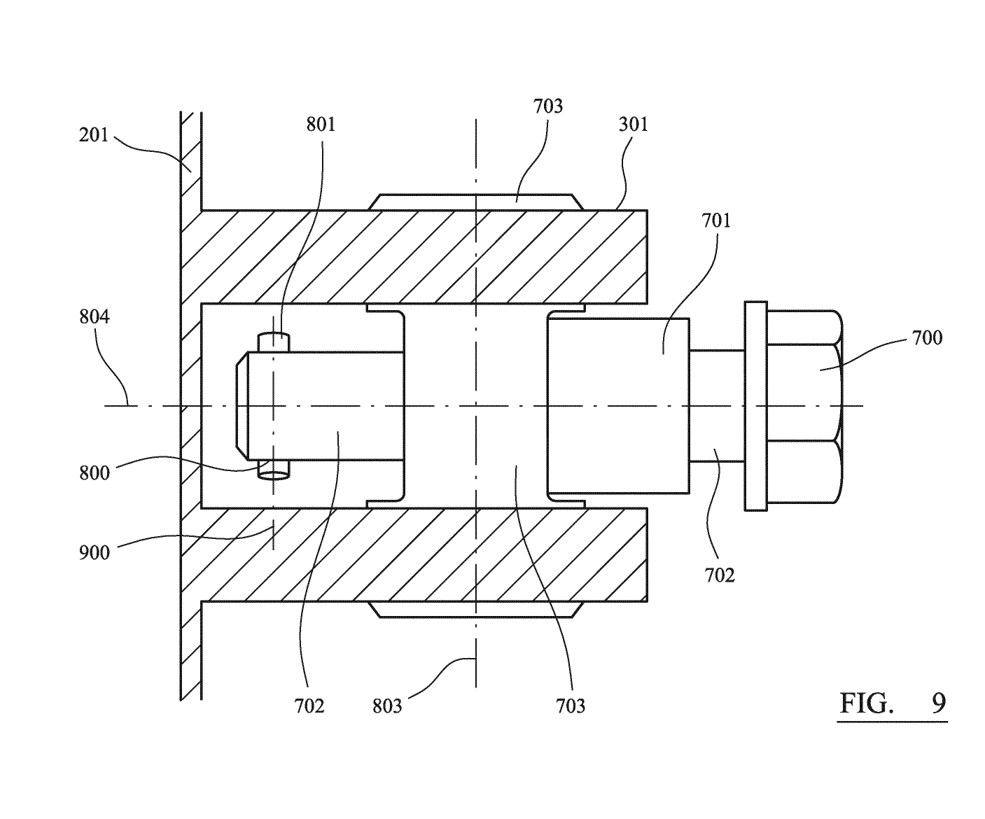

Referring to FIG. 7, a second half of the hinge mechanism 208 comprises a bolt having a bolt axle 702 and a bolt head 700 at one end. A spacer collar 701 extends around axle 702 and extends a distance along the length of axle 702. A barrel 703 comprises a generally cylindrical geometry and is connected to axle 702. Referring to FIG. 8, body 805 comprises barrel 703 having a longitudinal axis 803 aligned perpendicular to a longitudinal axis 804 of axle 702. A securing pin 801 extends through one end of axle 702 via a through bore 800. Pin 801 is positioned at a second end of axle 702 whilst head 700 is positioned at the opposite first end. Additionally, pin 801 comprises a longitudinal axis 900 aligned perpendicular to axis 804.

Axle 702 extends through the body of barrel 703 via a through bore 802. Collar 701, extending around axle 702, is positioned between head 700 and barrel 703. Axle 702 is capable of advancing and retracting through barrel 702 via cooperation of corresponding screw threads (not shown) formed on an external surface of axle 702 and formed internally within bore 802. Accordingly, axle 702 may be screwed through barrel 703 via head 700. Axle 702 is prevented from detachment from barrel 703 by virtue of head 700 comprising a greater radial diameter than bore 802 and pin 801 that projects beyond bore 800 such that a length of pin 801 is greater than the diameter of bore 802.

Referring to FIG. 9, the function of each hinge mechanism 208 is interchangeable in that body 805 is located at all four hinge mounts 300 (created by arms 301 and apertures 302) and is capable of functioning as a part of a hinge or a lock mechanism. That is, according to one embodiment the lock body 206 comprises the same arrangement and components as the body 805 including in particular axle 702, pin 801, barrel 703, collar 701 and head 700. According to further embodiments, the hinge body does not comprise pin 801 and comprises an axel 702 that is shorter in length than the corresponding length of axle 702 of the lock body 206.

Each barrel 703 is dimensioned so as to sit within apertures 302 of each pair of arms 301. Accordingly, the longitudinal axis 803 of barrel 703 is aligned parallel to vertical walls 201. Body 805 is secured to door 203 at its hinge edge 204 as shown in FIG. 7 as axle 702 passes through the door body and is secured in position by head 700 clamping against external surface 600. Axle 702 and accordingly door 203 is therefore supported by each respective pair of arms 301 and is capable of pivoting about longitudinal axis 803 of both barrels 703 to allow door 203 to swing to and fro at frame wall 201.

When employed as the lock mechanism and not the hinge mechanism, the outer end of axle 702 towards head 700 is capable of pivoting into each respective slot 502 as door 203 is brought to the hatch closed position. When in this position, each head 700 may be rotated to clamp against a region of external surface 600 to lock the door 203 in the closed position.

As the frame 200 comprises identical sets of arms 301 at both opposite vertical walls 201 the door 803 may be secured and hingeably mounted at either side wall 201 by simply removing bolts 700, 702, rotating door 203 through 180° and reattaching the door via its hinge edge 204 at the opposite set of mounts 300 at the opposite frame wall 201. Accordingly, the present hatch is configured to be both left and right hand opening. Additionally, the lock mechanism is also capable of actuation at either the right or left wall 201. Accordingly, the present hatch comprises four pivotally mounted bodies 805 secured at each four hinge mounts 301 with the bodies 805 acting as either the hinge mechanism or the lock mechanism by interchanging the respective bolts (700, 702). As bodies 805 are retained in position at each mount 300, door 203 may be conveniently interchanged between left and right hand opening by adjustment of heads 700 using an appropriate tool (not shown).

1. A crusher feed hopper hatch comprising:
a frame for attachment to a hopper, the frame having walls that define an opening;
at least one first hinge mount positioned at a first wall of the frame;
a door configured for positioning against the walls;
at least one second hinge mount positioned at a second wall of the frame; and
at least one body provided at the door, the body configured to mate with either the first and the second hinge mount to pivotally mount the door at either the first or the second wall.

2. The hatch as claimed in claim 1 wherein the first wall and the second wall are positioned on opposite sides of the frame.

3. The hatch as claimed in claim 1 further comprising a lock body mountable at either the first and second hinge mounts that engage with a region of the door and locks the door in position at the frame in a hatch closed position.

4. The hatch as claimed in claim 3, wherein the body is positioned towards a hinge edge of the door, the door having an opposed opposite lock edge engageable by the lock body.

5. The hatch as claimed in claim 3, wherein the lock body is pivotally mounted at either the first and the second hinge mount and includes an engaging end to engage a region of the door.

6. The hatch as claimed in claim 4, wherein the lock edge comprises includes at least one slot engageable by the engaging end of the lock body by pivoting the lock body at either the first and second hinge mount.

7. The hatch as claimed in claim 1, wherein the first and second hinge mount each include a pair of shoulders spaced apart at the wall, each shoulder having an aperture.

8. The hatch as claimed in claim 7, wherein the body includes a barrel having a longitudinal axis and is mountable between the pair of shoulders within each aperture so as to be rotatable within each aperture and allow the door to pivot between a hatch open and a hatch closed position.

9. The hatch as claimed in claim 8, wherein the barrel is mounted upon an axle extending from the door, the axle having a longitudinal axis extending substantially perpendicular to the longitudinal axis of the barrel.

10. The hatch as claimed in claim 7, wherein the lock body includes a barrel having a longitudinal axis and is mountable between the pair of shoulders within each aperture so as to be rotatable within each aperture.

11. The hatch as claimed in claim 10, wherein the lock body includes an axle having a longitudinal axis aligned substantially perpendicular to the longitudinal axis of the barrel, the axle being adjustably mounted relative to the barrel so as to extend and retract radially relative to the longitudinal axis of the barrel.

12. The hatch as claimed in any preceding claim 1, comprising two hinge mounts provided at each of the first and second walls; and the door comprising two bodies engageable with the two respective hinge mounts on either the first or second walls.

13. The hatch as claimed in any preceding claim 1, further comprising a sealing gasket extending between the door and the frame to provide a seal when the door is in a hatch closed position at the frame.

14. A crusher hopper comprising a hatch, the hatch including a frame for attachment to a hopper, the frame having walls that define an opening; at least one first hinge mount positioned at a first wall of the frame; a door configured for positioning against the walls; at least one second hinge mount positioned at a second wall of the frame; and at least one body provided at the door, the body configured to mate with either the first and the second hinge mount to pivotally mount the door at either the first or the second wall.

15. A crusher comprising a hopper, the hopper having a hatch, the hatch including a frame for attachment to a hopper, the frame having walls that define an opening; at least one first hinge mount positioned at a first wall of the frame; a door configured for positioning against the walls; at least one second hinge mount positioned at a second wall of the frame; and at least one body provided at the door, the body configured to mate with either the first and the second hinge mount to pivotally mount the door at either the first or the second wall.
